(19) United States
(12) Patent Application Publication
(10) Pub. No.: US 2017/0176573 A1
(43) Pub. Date: Jun. 22, 2017

(54) APERTURE CODING FOR A SINGLE APERTURE TRANSMIT RECEIVE SYSTEM

(71) Applicant: GM Global Technology Operations LLC, Detroit, MI (US)

(72) Inventor: Jonathan J. Lynch, Oxnard, CA (US)

(21) Appl. No.: 14/976,452

(22) Filed: Dec. 21, 2015

(51) Int. Cl. G01S 7/35

(52) U.S. Cl. CPC G01S 7/35

(57) ABSTRACT

An integrated circuit (IC) of a frequency-modulated continuous wave (FMCW) coded aperture radar (CAR) configured to step through a range of frequencies in each sweep and a method of assembling the FMCW CAR are described. The IC includes an antenna element to transmit and receive at a given time duration, a transmit channel to process a signal for transmission, the transmit channel including a transmit switch to change a state of a transmit phase shifter between two states based on a first code, and a receive channel to process a received signal, the receive channel including a receive switch to change a state of a receive phase shifter between two states based on a second code. The IC also includes a switch controller to control the first code and the second code, wherein the switch controller controls the first code to remain constant within the sweep.

### FIELD OF THE INVENTION

The subject invention relates to aperture coding for a single aperture transmit receive system.

### BACKGROUND

Certain radar applications require high angular resolution. High-angular resolution requires a large aperture sensor array, which requires elements separated by a half wavelength. This leads to a large number of sensors and transmit/receive channels. The large number of transmit and receive channels can prove impractical due to their large cost. In addition to high angular resolution, low sidelobes are also important in radar sensors. Low sidelobes better isolate the angular location of objects and keep strong scatterers from dominating the signals when they are directly adjacent to weaker scatterers. For example, in the automotive application, trucks, which are strong scatterers, may be prevented from dominating the signals over motorcycles, which are relatively weaker scatterers, by keeping sidelobes low. Further, the ability to use fast Fourier transform (FFT) processing at the receiver, rather than correlation processing, simplifies the receiver in the radar system. Accordingly, it is desirable to provide a radar system that provides digital beamforming on both the transmit and the receive sides with multiplicative patterns while maintaining the ability to use FFT processing.

### SUMMARY OF THE INVENTION

According to an exemplary embodiment, an integrated circuit (IC) of a frequency-modulated continuous wave (FMCW) coded aperture radar (CAR) configured to step through a range of frequencies in each sweep includes an antenna element configured to transmit and receive at a given time duration; a transmit channel configured to process a signal for transmission, the transmit channel including a transmit switch configured to change a state of a transmit phase shifter between two states based on a first code; a receive channel configured to process a received signal, the receive channel including a receive switch configured to change a state of a receive phase shifter between two states based on a second code; and a switch controller configured to control the first code and the second code, wherein the switch controller controls the first code to remain constant within the sweep.

According to another exemplary embodiment, a method of assembling a frequency-modulated continuous wave (FMCW) coded aperture radar (CAR) implemented on an integrated circuit to step through a range of frequencies in each sweep includes disposing an antenna element to transmit and receive at a given time duration; arranging a transmit channel to process a signal for transmission; changing, using a transmit switch of the transmit channel, a state of a transmit phase shifter between two states based on a first code; arranging a receive channel to process a received signal; changing, using a receive switch of the receive channel, a state of a receive phase shifter between two states based on a second code; and controlling the first code and the second code using a switch controller, the switch controller controlling the first code to remain constant within the sweep.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a block diagram of a coded aperture radar formed on an integrated circuit according to an exemplary embodiment; and

FIG. 2 is a block diagram of a system of CAR ICs according to an exemplary embodiment.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

Embodiments of the systems and methods detailed herein relate to a radar system with digital beamforming (DBF) of transmit and receive beams with multiplicative beam patterns. Exemplary applications of the embodiments include autonomous driving and high-end active sensing features in vehicles. The embodiments are equally applicable to vehicle applications (e.g., automobiles, farm and construction vehicles) and to non-vehicle applications (e.g., consumer electronics, appliances, manufacturing systems). Single-bit transceiver codes are used, as detailed below, such that FFT processing may be performed. Each transceiver may transmit and receive simultaneously. Thus, a compact radar sensor is also achieved through the use of a single antenna aperture for both transmit and receive. While the receiver codes are changed within a sweep, the transmitter codes are held constant within a sweep and may be changed between sweeps. For the receiver, the code sequence used within a sweep may be repeated in the next sweep.

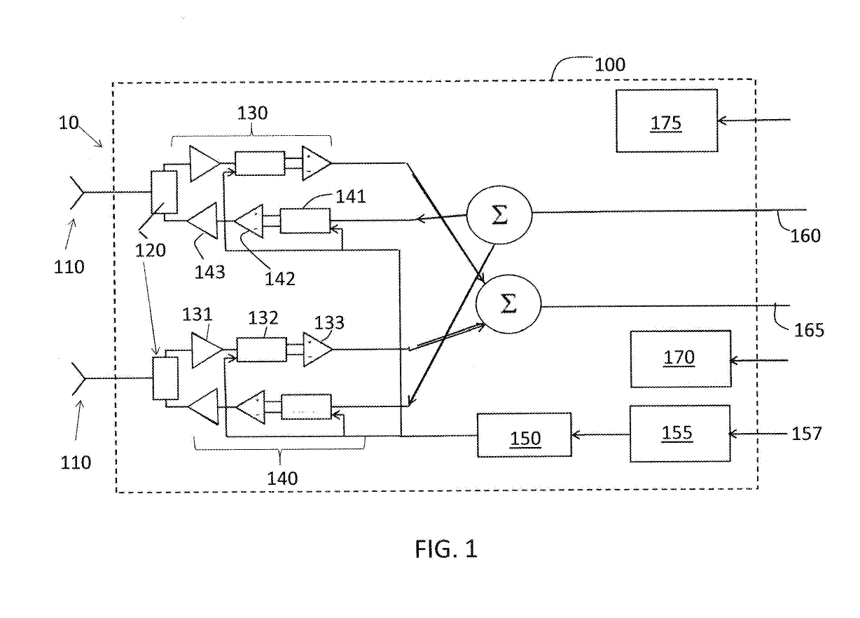

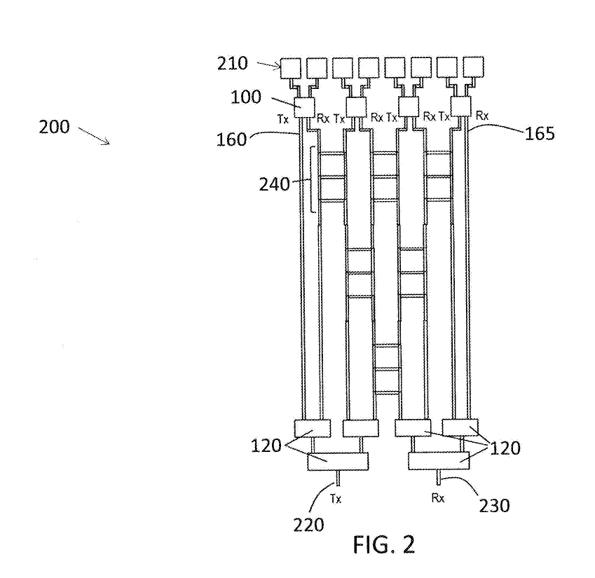

In accordance with an exemplary embodiment of the invention, FIG. 1 illustrates a coded aperture radar (CAR) 10 integrated circuit (IC) 100. A plurality of the ICs 100 may be used together. Further, the CAR 10 includes other components (e.g., mixer, analog-to-digital converter) outside the IC 100 that are known and not discussed herein. Two antenna elements 110 are shown in the exemplary embodiment, but any number of antenna elements 110 may be associated with the IC 100 based on size constraints on the IC 100. Each antenna element 110 both transmits and receives during the same time duration. This is possible based on a divider-combiner 120 (e.g., Wilkinson divider/combiner) associated with each antenna element 110. The divider-combiner 120 is shown as being on the IC 100, but, in alternate embodiments, the divider-combiner 120 may be off-chip alternately or (as in FIG. 2) additionally. The divider-combiners 120 shown on IC 100 in FIG. 1 function as dividers that divide transmit energy from receive energy. Each antenna element 110 has an associated transmit channel 140 and receive channel 130. The receive channel 130 includes a low noise amplifier (LNA) 131, a receive code switch 132, and a differential amplifier 133. Each transmit channel 140 includes a transmit code switch 141, a differential amplifier 142, and a power amplifier (PA) 143. In the exemplary embodiment, each transmit channel 140 on the IC 100 receives a single transmit RF input 160 that is split between the transmit channels 140, and energy received in each of the receive channels 130 is summed to a single received RF output 165. The divider-combiner 120 is disposed between each antenna element 110 and its associated transmit channel 140 and receive channel 130 to separate the transmitted and received waves at the antenna ports. The divider-combiner 120 (e.g., Wilkinson divider/combiner) is simpler to implement in complementary metal-oxide-semiconductor (CMOS) than a circulator that is traditionally used to transmit and receive simultaneously. In alternate embodiments, a circulator may be used instead of the divider-combiner 120. In alternate embodiments, the receive code switch 132 and transmit code switch 141 may be implemented as discrete diodes mounted on printed circuit boards (PCBs) rather than ICs 100 and, specifically, CMOS ICs.

The receive code switch 132 and transmit code switch 141 of each receive channel 130 and transmit channel 140 pair control the state of a phase shifter associated with the respective receive channel 130 and transmit channel 140, respectively. The binary code controls the state of the phase shifter with synchronization maintained through a clock 170 input to the IC 100. Direct current (DC) power input 175 is also provided to the IC 100. The receive code switch 132 and transmit code switch 141 are controlled by a switch controller 150 that may include switch control logic and a buffer. The switch control logic ensures that the correct code is sent to each receive code switch 132 and transmit code switch 141. The switch controller 150 is controlled by a serial data and chip select module 155 that receives serial data 157 from off the IC 100.

According to one embodiment, the transmit code switch 141 is maintained (same phase state is maintained for a transmit signal) over an entire sweep of frequencies. The transmit code switch 141 may change the code (phase) of the transmit signal from one sweep to the next. Assuming that the round trip time delay to and from the furthest scattering object (subjected to the transmit energy) is significantly less than the sweep period (e.g., one tenth), holding the transmit phase constant over a sweep facilitates the use of simple FFT processing (rather than correlation processing) of resulting received signals. This is because the transmit signal reflects off various objects located at different distances such that the reflected signals are received at different times. If the time delays associated with the different reflected signals are significant relative to the transmit code period, the received signals must be shifted in time to correctly de-correlated them. But, by holding the transmit code constant over each sweep, all the received signals contain the same transmit phase (code) and may be processed without compensating for such time delays.

According to an embodiment, the receive code switch 132 is changed (phase is changed) at each frequency step within a sweep. Further, according to one embodiment, the same receive code (the sequence defined by changing the code from frequency to frequency within the sweep) may be repeated from sweep-to-sweep. When the codes are changed (based on the receive code switch 132) at each frequency step, the code duration is very short, but demodulation of the received codes is facilitated by the fact that signals on the receive side are all modulated at the same time (with no delays in receive coding). The code being held constant over a sweep on the transmit side and the repetition of the code sequence from sweep to sweep on the receive side results in multiplicative transmit and receive patterns. Sidelobes may be reduced significantly by utilizing (digitally computed) high gain patterns on both the transmit and receiving arrays, with the net pattern being the product of the two patterns. Thus, the multiplicative patterns resulting from embodiments detailed herein provide reduced sidelobes, for example, from 20 dB to 40 dB below the main lobe. In alternate embodiments, the code on the receive side may not be repeated from sweep-to-sweep. Although the same array is used for transmit and receive, the transmit code switch 141 and receive code switch 132 facilitate formation of separate transmit and receive beams. The code sequence implemented by each transmit code switch 141 and each receive code switch 132 may be based on an independent, pseudorandomly chosen code.

FIG. 2 is a block diagram of a network 200 of CAR ICs 10 according to an exemplary embodiment. The network 200 illustrates the embodiment noted above of additional divider-combiners 120 being off-chip. Specifically, off-chip dividing and combining networks are implemented using PCB technology. In the exemplary embodiment shown in FIG. 2, each IC 100 supports two patch antennas 210 that each transmit and receive. The transmit RF input 160 is fed to all of the ICs 100 through a dividing network that distributes a single transmit signal 220, which may be generated by a voltage controlled oscillator (VCO), for example. The division of the transmit signal 220 is via divider-combiners 120 that function as dividers, as shown in FIG. 2. The received RF output 165 from all of the ICs 100 are combined through a network to a single receive output 230 for down-conversion by a mixer, for example. The combination of the received RF outputs 165 is accomplished with divider-combiners 120 that function as combiners, as shown in FIG. 2. Cascaded branchline coupler cross-overs 240, as shown in FIG. 2, or cross over circuit traces according to alternate embodiments, may be used to route and exchange transmit and receive signals (160, 165) among the different ICs 100.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An integrated circuit (IC) of a frequency-modulated continuous wave (FMCW) coded aperture radar (CAR) configured to step through a range of frequencies in each sweep, comprising:
an antenna element configured to transmit and receive at a given time duration;
a transmit channel configured to process a signal for transmission, the transmit channel including a transmit switch configured to change a state of a transmit phase shifter between two states based on a first code;
a receive channel configured to process a received signal, the receive channel including a receive switch configured to change a state of a receive phase shifter between two states based on a second code; and
a switch controller configured to control the first code and the second code, wherein the switch controller controls the first code to remain constant within the sweep.

2. The IC according to claim 1, wherein the switch controller controls the receive switch based on the second code to change the state of the receive phase shifter between each adjacent frequency in the sweep to form a sequence.

3. The IC according to claim 1, wherein the switch controller controls the second code to repeat the sequence for each subsequent sweep.

4. The IC according to claim 1, further comprising a plurality of the antenna elements, each associated with corresponding ones of the transmit channel and the receive channel.

5. The IC according to claim 4, wherein the switch controller independently controls the transmit switch and the receive switch corresponding to the transmit channel and the receive channel associated with each of the plurality of the antenna elements.

6. The IC according to claim 5, wherein the switch controller control is based on a control signal provided to the integrated circuit.

7. The IC according to claim 1, wherein the switch controller controls the transmit switch to change the state of the transmit phase shifter between the sweep and a next sweep.

8. The IC according to claim 1, further comprising a Wilkinson divider to facilitate simultaneously transmitting and receiving with the antenna element.

9. A method of assembling a frequency-modulated continuous wave (FMCW) coded aperture radar (CAR) implemented on an integrated circuit to step through a range of frequencies in each sweep, the method comprising:
disposing an antenna element to transmit and receive at a given time duration;
arranging a transmit channel to process a signal for transmission;
changing, using a transmit switch of the transmit channel, a state of a transmit phase shifter between two states based on a first code;
arranging a receive channel to process a received signal;
changing, using a receive switch of the receive channel, a state of a receive phase shifter between two states based on a second code; and
controlling the first code and the second code using a switch controller, the switch controller controlling the first code to remain constant within the sweep.

10. The method according to claim 9, wherein the controlling the first code includes changing the first code between the sweep and a next sweep.

11. The method according to claim 9, wherein the controlling the second code includes changing the state of the receive phase shifter between each adjacent frequency in the sweep to form a sequence.

12. The method according to claim 11, wherein the controlling the second code further comprises repeating the sequence for each subsequent sweep.

13. The method according to claim 9, further comprising disposing a plurality of the antenna elements, each associated with corresponding ones of the transmit channel and the receive channel.

14. The method according to claim 13, wherein the controlling includes independently controlling the transmit switch and the receive switch corresponding to the transmit channel and the receive channel of each associated with each of the plurality of the antenna elements.

15. The method according to claim 14, wherein the controlling is based on a control signal provided to the integrated circuit.
